(19) United States
(12) Patent Application Publication
(10) Pub. No.: US 2018/0020183 A1
(43) Pub. Date: Jan. 18, 2018

(54) ELECTRONIC CONTROL UNIT AND METHOD FOR REPRODUCING AUDIO AND/OR VIDEO OR HOLOGRAPHIC DATA

(71) Applicant: Sliven Christov Andreev, Sofia (BG)

(72) Inventor: Sliven Christov Andreev, Sofia (BG)

(21) Appl. No.: 15/653,066

(22) Filed: Jul. 18, 2017

(30) Foreign Application Priority Data
Jul. 18, 2016 (DE) 10 2016 113 178.4

(51) Int. Cl. H04N 5/775; H04N 21/439; H04N 21/41; H04N 21/414; H04N 21/462; H04N 21/44

(52) U.S. Cl. CPC H04N 5/775; H04N 21/462; H04N 21/44008; H04N 21/4122; H04N 21/41422; H04N 21/4126; H04N 21/4394

(57) ABSTRACT

The disclosure, which concerns an electronic control unit for reproducing audio and/or video or holographic data, is based on the problem of indicating a solution which enables a secure coupling and reproducing of audio and/or video or holographic data between an external unit and the electronic control unit in regard to mandatory standards or protocols.

### CROSS-REFERENCE TO RELATED APPLICATION

This application claims priority to German Patent Application No. 10 2016 113 178.4 filed Jul. 18, 2016, and entitled “ELECTRONIC CONTROL UNIT AND METHOD FOR REPRODUCING AUDIO AND/OR VIDEO OR HOLOGRAPHIC DATA,” which is herein incorporated by reference.

### BACKGROUND

The disclosure concerns an electronic control unit for reproducing audio and/or video or holographic data, being connected at the output to at least one display or holographic projector and a loudspeaker for outputting of audio and/or video or holographic data, wherein the electronic control unit comprises an interface module for producing a data connection for the transmission of the audio and/or video or holographic data between an external unit and the electronic control unit.

The disclosure also concerns a method for reproducing audio and/or video or holographic data, wherein an electronic control unit with an interface module is provided, the electrical control unit being connected via the interface module to an external unit for the transmission of audio and/or video or holographic data.

Electronic control units (ECU), also known as a controller, are employed in many vehicles to control various vehicle functions. These control units may, for example, control the operating behavior of an internal combustion engine, an air conditioning system, a sound system, a combined sound and video system, input and output systems for vehicle operation or other functions and subassemblies of a modern motor vehicle.

The focus of the present disclosure lies in the area of the coupling of an external unit such as a smartphone, a laptop or another intelligent portable device to an electronic control unit by which audio and/or video or holographic data which is provided by the external unit will be put out in the vehicle or placed on the display. The loudspeaker or a suitable display present in the vehicle should be used for this.

Even though not currently implemented in technical solutions today, it may nevertheless be presumed that in the near future holograms and video holograms will be part of the available output capabilities of intelligent mobile and portable devices. Thus, vehicles of the future will have electronic control units with holographic projectors and conventional displays for presentation of information. Furthermore, displays may also be used which provide a three-dimensional representation.

Intelligent mobile devices such as smartphones or tablets are very widespread and have a market penetration of around 50% in Europe and North America. In the Asian countries, the percentage is even around 65%. One may expect a further increase in the market penetration as well as the advent of additional intelligent devices, such as smart watches.

Such intelligent devices usually have GPS receivers, audio and video outputs, acceleration, position and proximity sensors. A variety of software applications (apps) can be executed on these devices, in which among other things audio and/or video or holographic data is also put out on the device itself.

Modern motor vehicles offer functions such as an infotainment system, satellite navigation, a digital music player and others, which may also be present on a portable device. Since portable mobile devices are usually more versatile in handling media content thanks to their ability to update or reinstall existing or new applications, it is desirable to couple these devices to an electronic control unit present in the vehicle and thereby utilize their advantages. An integration of new applications, such as those in the area of the music player or navigation, is usually not possible for the user of a motor vehicle.

Several methods are known in the prior art for the coupling and transmission of data between mobile devices and an electronic control unit in the vehicle. Such a coupling may be either wireline or wireless. Transmission standards are known for this, such as USB, Bluetooth or WiFi and others.

Security protocols and also standards, for example, need to be observed in the coupling of an external device to the electronic control unit and a transmission of data, especially audio and/or video or holographic data.

As a rule, the protocols and standards in the development of mobile devices and corresponding applications do not conform to the protocols used in the automotive industry. One standard observed in the field of auto makers and auto parts suppliers is ISO 26262, which contains protocols for security-relevant electrical or electronic systems in motor vehicles.

If the protocols of this standard are observed, the use of intelligent portable or intelligent mobile devices in vehicles and their coupling to a control unit for outputting of audio and/or video or holographic data can be very advantageous. For example, vehicle or software manufacturers as well as parts suppliers can develop applications for the mobile devices which are executed by a user in a vehicle.

In this way, on the one hand, the number or the complexity of the necessary electronic control units in the vehicle can be reduced. On the other hand, trends such as carsharing can be supported, since the user installs his preferred applications on his intelligent portable or intelligent mobile device, such as a smartphone, and can use them in different vehicles.

Furthermore, it is possible in this way for a user of a motor vehicle to influence the applications required or preferred by him which are provided to him during the use of a motor vehicle or his motor vehicle.

From WO 2012079724 A1 there is known a method for operating by means of a motor vehicle a mobile device not associated with a motor vehicle. For this, a program able to run on the mobile device and a digital certificate associated with the program are stored in the mobile device, the digital certificate being sent from the mobile device to the motor vehicle.

It is provided that the digital certificate is verified in the motor vehicle, whereupon—if the verification of the digital certificate is successful—information associated with the program able to run on the mobile device is presented by means of a display of the motor vehicle, and the program able to run on the mobile device is operated by means of an operating arrangement of the motor vehicle associated with the display.

From WO 2015033761 A1 there is known an electronics communication system with a portable terminal device and a device mounted in a vehicle. The portable terminal device has a first and a second device-side communication unit as well as an application function unit.

The vehicle has a first and a second vehicle-side communication unit as well as a playback unit for outputting of media contents.

The drawbacks of the known prior art lie in particular in the lack of a capability of checking the contents such as audio and/or video or holographic data transmitted from an external unit such as a smartphone for compliance with the rules and protocols applying to vehicles.

### BRIEF DESCRIPTION OF DRAWINGS

Further details, features and benefits of embodiments of the disclosure will emerge from the following description of sample embodiments with reference to the corresponding drawings. There are shown:

FIG. 1: a basic diagram of one embodiment of the electronic control unit according to the disclosure.

### SUMMARY

The problem which the disclosure proposes to solve is to provide an electronic control unit as well as a method for reproducing audio and/or video or holographic data, which enables a secure coupling and reproducing of the audio and/or video or holographic data between an external device and the electronic control unit in regard to mandatory standards or protocols. In particular, the driver while driving the motor vehicle should not be distracted by the audio and/or—or holographic data provided by the external device and relevant security protocols should be observed.

The problem is solved by an object with the features of patent claim 1 of the independent patent claims. Modifications are indicated in the dependent patent claims.

The present disclosure makes it possible to analyze audio and/or video or holographic data of an external device connected to the electrical control unit for data transmission, such as a smartphone or tablet, within a subassembly of the electronic control unit.

It is provided for this analysis of the audio and/or video or holographic data to be done in a real-time processing, so as to avoid delays or information losses during the presentation of the audio and/or video or holographic data in the motor vehicle.

It is advantageous to perform this analysis by using predefined rules in order to make the analysis fast and efficient. These rules, for example already established prior to the placing of the electrical control unit in operation, are saved in a memory accessible to the electrical control unit or in the electrical control unit itself. Besides a saving in a memory or memory region, an integration of the rules in a program portion which can be executed by the electrical control unit may also be done.

It is provided that the rules may be updated or replaced and an adapting to the changing protocols or standards of other countries can be done in this way.

Furthermore, it is provided that an outputting of such analyzed audio and/or video or holographic data occurs on a display controlled by the electronic control unit in the motor vehicle in the event that no violation against one of the predefined rules has been identified.

The display can be any display ordinarily used in the vehicle, for example, one which is suitable for the outputting of video contents. In particular, it can be the available color display or a so-called head-up display (HUD).

In addition, the use of appropriately configured holographic projectors is provided for the presentation of holographic data. Such a presentation, which is also called a hologram, may be for example a three-dimensional representation of an original object. Furthermore, information on the state of the motor vehicle or selected systems of the vehicle may also be displayed in a three-dimensional form.

The audio and/or video or holographic data furnished by an external unit is verified in the electronic control unit in real time for observance of the predefined rules. In the event that no rule violation was identified, the audio and/or video or holographic data is forwarded for output in a loudspeaker, a display or a holographic projector.

In the event that one or more rule violations were identified, the audio and/or video or holographic data is not forwarded, nor is it put out. In this case, it is provided that established predefined audio and/or video or holographic data is put out as an alternative, representing for example a dark display or a sound or text output, such as an error message.

The rules verified by the electrical control unit may be, for example, instructions as to the maximum allowable proportion of nontransparent pixels in a video or a hologram, a minimum or maximum allowable text or font size, a minimum or maximum allowable image or pictogram size, a maximum allowable size of blinking font characters or pictograms, as well as their minimum or maximum allowable blinking frequency.

The present disclosure thus offers the following advantages:
wireless or wireline coupling of portable external devices (intelligent portable devices, smart watches, smartphones, laptops, notebooks, tablets, music or video players) to the electronic control unit making use of various standards (USB, Bluetooth, WiFi, MirrorLink)
use of the available display and entry capabilities in the vehicle (LCD display, HUD, contact and/or proximity sensors)
integration of driver interactions (information on speed, engine revolutions, engine temperature, fuel level, battery charge state, informational or warning messages)
control of communication (CAN Bus Controller Area Network, LIN Local Interconnect Network), diagnostics, system starting, message or display settings (LCD display or HUD, adjustment angle of the HUD, brightness, contrast, backlighting, power management by the electronic control unit
outputting of the audio and/or video or holographic data of the external unit by means of the loudspeaker and/or display controlled by the electronic control unit
generating of feedback to the coupled external unit by means of available data entry sensors used by the vehicle driver
providing of a control manager which is able, during ongoing output of audio and/or video or holographic data, to put out warning or error messages superimposed on the audio and/or video or holographic content, establishing of priorities in the outputting of the warning or error messages
verification of the audio and/or video or holographic data received from the external unit prior to its outputting in the motor vehicle making use of predefined rules and preventing of the outputting of the audio and/or video or holographic data when a rule violation is identified.

Upon identifying one or more rule violations, it is provided for example not to allow the outputting by the electronic control unit of the video or holographic data received from the external unit. For this, it is provided to replace the received video or holographic data with video or holographic data stored in the electronic control unit and thereby realize for example a display of a black screen. Alternatively, other colors or also characters or error messages may be put out, by means of which an identified rule violation can be signified to the driver.

Advantageously, the duration as well as the content of the alternative audio and/or video or holographic data put out in event of a rule violation may be varied at will. Thus, an error message may be put out for example for a predetermined minimum duration (such as 10 or 20 or 30 seconds).

### DETAILED DESCRIPTION

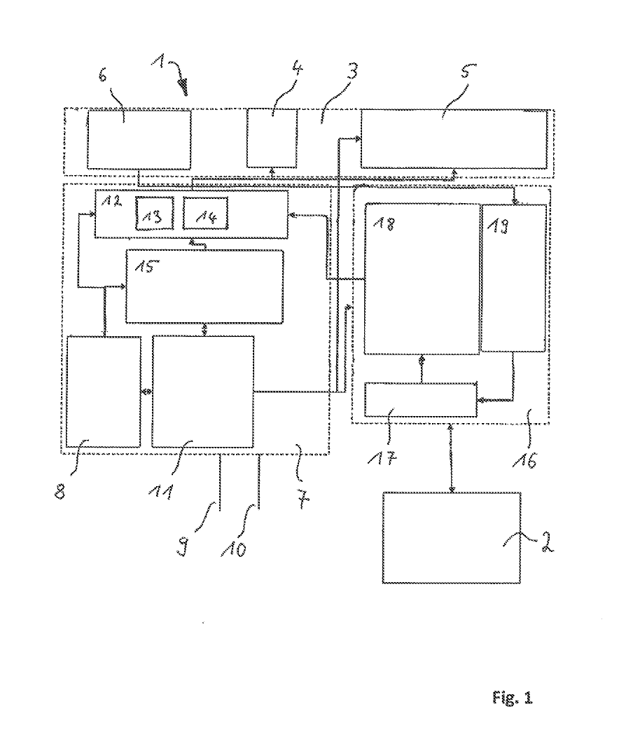

FIG. 1 represents a first sample embodiment of the electronic control unit 1 according to the disclosure, arranged for example in a motor vehicle. This electronic control unit 1 makes it possible to put out data, such as audio and/or video or holographic data, which [comes from?] an external unit 2 connected to the electronic control unit 1, for example in wireless manner.

The basic diagram shown in FIG. 1 is divided up into several internal subsystems 3, 7 and 16 of the electronic control unit 1 as well as the external unit 2. The external unit 2 constitutes an intelligent, portable, mobile device, such as a smartphone, a smart-watch, a laptop, a notebook, a tablet or a handheld device. Software applications (programs, apps) are executed on this unit 2, which put out audio and/or video or holographic data (music player, video player, navigations app and others) and send [this data?] by means of a transmission standard such as WiFi, Bluetooth, MirrorLink or others to an interface module 17 of the electronic control unit 1 in the motor vehicle.

In this specification, the term audio and/or video or holographic data shall be used in general. This is data which may be both audio data as well as video or holographic data or image data, not limited to a particular standard or a particular format. It encompasses all usual formats at the time of writing of the specification such as in particular the audio formats MP3, WAV, WMA, AAC as well as the video formats WMV, MPEG I, MPEG II, MPEG IV, AVI, MOV and FLV. It also includes image data, for example in the formats JPEG, JPG, PNG, GIF, TIF and BMP.

The first subsystem of the electronic control unit 1 constitutes an output system, by which audio and/or video or holographic data may be put out. For example, the first subsystem 3 comprises a loudspeaker 4 as well as a display 5. The image or video data being put out may be represented such that the entire available region of the display or only a partial region of the display is used for outputting the image or video data being represented. If only a partial region of the display is used, a representation of usual vehicle or status information may occur in the region not used for the image or video data being put out. Such vehicle information may be, for example, the speed, the engine revolutions, the engine temperature, the gear engaged, the full level of a fuel tank, and many other items. As status information, there can also be displayed for example information of a radio receiver, an audio system, an air conditioning system or a navigation system.

For the entry of information by the user of the motor vehicle, one or more sensors 6 may be provided in a separate region or in the display 5, being designed as contact or proximity sensors. Through these sensors, the driver may for example enter information, confirm an action, or make a selection. Alternatively, other input from the driver is also possible via buttons or switches, of course.

The electronic control unit 1 furthermore has a second subsystem 7, which is connected to the first subsystem 3 for the outputting of audio, image, audio or video or holographic data. The second subsystem 7 comprises at least a first module 8 for providing driver interaction (DI) information, such as information on the vehicle's speed, a distance traveled, the air conditioning, the fuel level, and other items. The functioning of such a module 8 may also be provided by means of software (SW), of course, which is worked through in an arithmetic unit of the second subsystem 7, not shown in FIG. 1.

The second subsystem 7 is connected to an operating voltage 9 of the motor vehicle of 12 Volt, for example, for the power supply of the electronic control unit 1, as well as to a data bus 10 of the motor vehicle such as a CAN bus (CAN Controller Area Network) for the transmission of information between the electronic control unit 1 and other subassemblies of the motor vehicle such as a central control unit (controller). Such a central control unit is not shown in FIG. 1.

The second subsystem 7 also comprises a second module 11 or a corresponding program part with a switching logic for controlling the power supply within the electronic control unit 1. Furthermore, the second module 11 may also be provided to control the communication via the data bus 10 (CAN, LIN), for operating and/or diagnostics of the electronic control unit 1, such as during the starting of the vehicle, for controlling a backlighting of a display 5 and/or for indications and other functionalities.

Furthermore, the second subsystem 7 has a third module 12 with a memory or memory region 13 for the storing of audio and/or video or holographic data, for example, which has been transmitted from the external unit 2, such as a smartphone, to the electronic control unit 1. The audio and video or holographic data stored in this memory 13 may be put out on the display 5 of the first subsystem 3. Advantageously, the video or holographic data stored for example in the memory 13 can be merged with other information in a mixer 14. In this way, when putting out a video or a hologram, other information or other suitable output means can be shown in the display 5. This might be, for example, information on the run time, length, source and other information on the video being shown or vehicle or status information, such as the vehicle's speed, an incoming call, or a warning for the driver.

The electronic control unit 1 also has a third subsystem 16, which contains an interface module 17, an analysis module 18 and a data adapting module 19.

It is provided to realize, by means of the interface module 17, an adapting of the data transmission between the external unit 2 and the electronic control unit 1. The interface module 17 is designed so that it has functionalities of several wireline and wireless data transmission standards such as USB, Bluetooth, WiFi, MirrorLink and others. Besides the receiving of data from the external unit 2, it is also provided to send data from the electronic control unit 1 to the external unit 2 and thereby support a displaying of feedback or another action on the external unit 2.

The analysis module 18 is connected to the interface module 17 for the transmission of the audio and/or video or holographic data provided by the external unit 2. The analysis module 18 is designed so that it is able to undertake an analysis or verification of the audio and/or video or holographic data received from the external unit 2 in a real-time data processing.

For this analysis or verification of data in real-time, certain predefined rules are established, which are verified by the analysis module 18. These rules may be stored in a memory inside the electronic control unit 1 and be called up by the analysis module 18. For the storage, a memory located in the third subsystem 16 or the memory 13 of the second subsystem 7 can be used. Alternatively, these rules may be placed in the software controlling the electronic control unit 1.

In order to improve the system security, it may be provided to perform the functionalities of the analysis module 18 in a specially protected environment. For this purpose, the sandbox technique known from information technology may be used, for example.

If the analysis module 18 determines that a received video file is not allowed to be displayed according to one or more memorized rules (rule violation), a corresponding control signal is prepared and put out by the analysis module 18, thereby preventing a playback on a display 5 of the first subsystem 3. In this case, for example, instead of the video there may be shown a black screen. Alternatively, an error message or a general backdrop image with an error message may be displayed.

Otherwise, it may be provided that the analysis module 18 itself prevents the forwarding of the audio and/or video or holographic data received from the external unit 2 when a rule violation is identified.

The interface module 17 is also connected to the data adapting module 19, which receives information entered by the user via the sensors 6 and processes it so that this information is put out in a data format via the interface module 17 to the external unit 2 which can be processed by the external unit 2.

This adapting may involve a translating into a particular code as well as a compression of the data being transmitted or other methods of data transformation.

The data adapting module 19 may furthermore also realize a control of the data put out by the electronic control unit 1 to the external unit 2. In this way, one may prevent the external unit 2 from receiving data which is not allowed for transmission to the external unit 2. This measure improves the security of the electronic control unit 1, for example during an attack by malicious software.

Contrary to the solutions in the known prior art, in the present disclosure no transmission of vehicle information such as a vehicle's speed or information on the vehicle status is necessary. Since a transmission of this information to the external unit 2 is not necessary, it may also be effectively prevented by the data adapting module 19.

In the following, the mode of functioning of the electronic control unit 1 according to the disclosure shall be described with an example of the playback of a video file. It is understood that this example does not constitute any limitation of the present disclosure and holographic data, image data, or audio data for example can also be subjected to the same mode of operation.

On an external unit 2, a video file is prepared by means of an application software and presented for display. This video file is supposed to be provided to the electronic unit 1 of a motor vehicle. For this purpose, the external unit 2 is connected, for example wirelessly, via a Bluetooth connection to the interface module 17 of the electronic control unit 1.

Thus, the digital video data is presented at an input of the analysis module 18. The analysis module 18 or its functionalities may preferably be executed in a so-called sandbox (a secure environment for the execution of software programs). The sandbox technique affords the possibility of running the applications (software program) of the analysis module 18 in an especially protected environment. This ensures a secure mode of operation of the application and prevents a disturbance of the operation of the application for example by malicious software.

The analysis module 18 checks the received video data in real time with the aid of predefined rules for its suitability to reproduction inside the electronic control unit 1. These rules are placed for example in a memory of the electronic control unit 1, from which they may be called up and checked by the analysis module 18.

Such rules may be, for example, a maximum allowable proportion of nontransparent pixels in a video frame, a minimum or maximum allowable text or font size, a minimum or maximum size of a pictogram, a minimum or maximum size of a blinking text or pixel, the blinking frequency of a text or pixel, a minimum or maximum size of an image, a minimum or maximum resolution of a video, and many others. These rules are provided to the electronic control unit 1 and may be updated or replaced in a manner usually familiar to the skilled person.

In event of one or more rule violations by the data received from the external unit 2, these are identified by the analysis module 18 and a corresponding error or status signal is prepared and put out. Alternatively, predefined video and/or audio or holographic data may be provided for output by the analysis module 18 or another unit, such as from a memory region 13 of the second subsystem 7. This outputting of the predefined video and/or audio or holographic data may occur, for example, for the entire duration of an ongoing rule violation. Alternatively, the outputting of the predefined video and/or audio or holographic data may occur for an established duration of 5 or 10 seconds, for example. In another alternative, the outputting of the predefined video and/or audio or holographic data could continue until an entry in the form of a confirmation or acknowledgement by the vehicle driver is recognized. Such an entry may occur for example through the sensors 6 of the first subsystem 3.

If the analysis module 18 finds no rule violation, the audio and/or video or holographic data is forwarded via an output of the analysis module 18 to the third module 12 of the second subsystem 7.

Within the third module 12, the audio and/or video or holographic data is buffered for example in the memory region 13 and/or merged with other data in the mixer 14 and thereby prepared for the outputting in the first subsystem 3. Such other data might be, for example, information prepared in the first module 8 of the second subsystem 7 on the speed or distance traveled by the vehicle.

The memory region 13 as well as the mixer 14 of the third module 12 are connected to the control manager 15 and are controlled by it. The task of the control manager 15 involves in particular the controlling of the units connected to it in such a way that, upon occurrence of a warning or error signal, for example, the outputting of the audio and/or video or holographic data received from the external unit 2 is prevented, replaced, or supplemented in order to tell the driver about a critical vehicle condition, for example. For this purpose, the control manager 15 realizes a suitable output, such as a sound, a text, or a pictogram on the display 5 and/or the loudspeaker 4.

A warning or error signal may be provided to the control manager 15 for example by the first module 8 (e.g., low level of the fuel tank, engine temperature critical, and so on) or the second module 11 (e.g., battery/alternator defect, diagnostic defect, seatbelt not buckled, etc.). The control manager 15 then decides for example per predetermined priorities whether and how to notify the driver.

In an alternative mode of operation, the warning or error signals of the second module (11) may also be sent directly to the display (5) and be presented there.

For the providing of a warning signal, the control manager 15 may use for example contents from the memory 13 and insert these by means of the mixer 14 into an ongoing video transmission.

The control manager 15 in a special embodiment may also control the providing of audio and/or video or holographic data by means of which the audio and/or video or holographic data of the external unit 2 is covered over or replaced.

In the second module 11 of the second subsystem 7 functions are implemented by means of which a power management, a backlighting control, a communication with other control units of the vehicle, and others can be realized.

Thus, for example, the second module 11 may provide a needs-based power management of the interface module 17, during which the interface module 11 is switched off in the event that no external unit 2 is placed in the vehicle.

Furthermore, the second module 11 may also provide, for example, a power management for the analysis module 18, the data adapting module 19, the third module 12 and the first module 8.

By such a power management is meant, for example, an operation of the units with full power capability in a normal mode, an operation of the units with a limited capability in a standby mode, and a switching off of the units.

If the audio and/or video or holographic data verified in real time by the analysis module 18 is allowed for display by the electronic control unit 1, since none of the predetermined rules are violated, an outputting of the audio data occurs via the loudspeaker 4 of the first subsystem 3, while the loudspeaker 4 may also be a sound system installed in many vehicles. An outputting of the video or holographic data is done for example via the display 5 of the first subsystem 3. The outputting of the audio and/or video or holographic data can be controlled for example by entries through the sensors 6 of the first subsystem 3. For example, settings for the playback qualities of the audio and/or video or holographic data can be adjusted through the sensors 6. In a special embodiment, it is provided that the information detected through the sensors 6 is processed by the data adapting module 19 and transmitted via the interface module 17 to the external unit 2. By means of this transmitted data, the playback of a video can be controlled in the external unit 2, for example, by generating and sending control commands for the functions “start”, “stoop” or “pause”.

Software applications (apps) can be purchased and downloaded online, for example through platforms like “Google Play” and others. In this context, it is important that the user has an assurance that the respective software application obeys the mandatory protocols and works reliably.

In this context, it is provided that manufacturers of electronic control units or original equipment manufacturers (OEM) which manufacture the subassemblies suitable for the processing of audio and/or video or holographic data publish the rules verified by the control units. Thus, developers of software applications will be able to learn of these rules and heed them in the development of their products. In this way, the user is protected against errors during the operation of the devices and apps. A general standardization of the commonly used rules is also desirable.

Furthermore, it is provided that the platforms which distribute corresponding apps offer an assessment possibility for the user or purchaser of the app. Thus, in the event that an app does not work for the user or does not work properly, it is ensured that an entry or comment can be made as to the corresponding software application, which informs potential users as to quality or problems prior to purchasing the app and thus protects these users.

It thus lies within the discretion of the user whether or not to use this app. In this regard, corresponding assessments of apps by means of scores are also known.

We claim:

1. A system for reproducing audio and/or video or holographic data, being connected at the output to at least one display and a loudspeaker for outputting of audio and/or video or holographic data, comprising:
an interface module being configured to provide a data connection for the transmission of the audio and/or video or holographic data between a third-party device and the system;
an analysis module being arranged in the electronic control unit, the analysis module being configured to analyze the audio and/or video or holographic data received from the external unit in via real-time processing,
wherein the analysis module is configured to perform the analysis by determining whether received data via the third-party device violates a predetermined rule, and in response to the determination being affirmative, filtering out the received data from presentation via the system,
the system being defined as an embedded in-vehicle electronic control unit.

2. The system according to claim 1, further comprising a memory and a mixer between the analysis module and the display.

3. The system according to claim 2, further comprising a control manager, the control manager being configured to control the memory and the mixer in response to a warning or error message being generated by the system.

4. The system according to claim 3, further comprising:
a sensor, the sensor being configured to detect entry of data from a user, the sensor being connected to an input of a data adapting module, an output of the data adapting module being connected to an input of an interface module, for transmission of the detected driver entry data to the external unit.

5. The system according to claim 4, further comprising a first module and a second module, which are connected to the control manager and the third module.

6. The system according to claim 1, further comprising a holographic projector.
